(19) United States
(12) Patent Application Publication
(10) Pub. No.: US 2006/0165849 A1
(43) Pub. Date: Jul. 27, 2006

(54) Edible manually holdable food product with hydrophilic liquid absorbent insert

(76) Inventor: Kenrick Rampersad, Brentwood, NY (US)

Correspondence Address: ALFRED M. WALKER, 225 OLD COUNTRY ROAD, MELVILLE, NY, 11747-2712, US

(21) Appl. No.: 11/318,249

(22) Filed: Dec. 23, 2005

Related U.S. Application Data
(60) Provisional application No. 60/639,494, filed on Dec. 27, 2004.

(51) Int. Cl. A21D 13/00

(52) U.S. Cl. 426/94

(57) ABSTRACT

A breadstick product includes a hard crusty shell of edible material having punched access holes. The outer shell is filled with an interior filling of edible hydrophilic material. The edible hydrophilic filling material is absorbent, preferably a bread product or a dehydrated hydrophilic filling material. The outer shell of the tangible breadstick product is a crusty outer shell, which is filled with the hydrophilic absorbent product, such as dehydrated bread, which can be submerged in hot liquids, such as coffee, tea or soup. The hot liquid is accessed through the access holes in the crusty outer shell, while the crusty shell maintains its integrity when dipped and exposed to the hot liquid, such as coffee, tea or soup.

### RELATED APPLICATIONS

### Cross Reference to Related Applications

This application claims the benefit, Under 35 U.S.C. 119(e) of U.S. Provisional Application No. 60/639,494, filed Dec. 27, 2004, which is hereby incorporated by reference.

### FIELD OF THE INVENTION

The present invention relates to structurally integral, manually holdable foodstuff snacks.

### BACKGROUND OF THE INVENTION

Rolls or traditional bread based sandwiches dissolve quickly in hot liquids, such as coffee, tea or soup. While this does not present a problem for a person seated at a dining table with utensils and plates easily accessible for handling the bread subject to dissolution, for workers in the field, such as bricklayers, landscapers or other construction workers, the situation is different. These field workers often eat at the job site, without the luxury of sitting at a table with utensils or plates to accommodate soft food, such as bread or other bread product dipped in hot liquids, such as coffee, tea or soup. When bread or a bread product is dipped into the hot liquid, it breaks up, becomes mushy and can't be handled. In addition, it drips over the hands of the worker, making an unpleasant eating experience in tough enough working conditions.

While it is known to fill crusty cookies with hydrophobic oil based products, such as creams or jellies, what is needed is a tangible breadstick product having a crusty outer shell with limited liquid absorption properties, but which is filled with a hydrophilic product, such as dehydrated bread, which can be submerged in hot liquids accessed through access holes in the crusty outer shell, while the crusty shell maintains its integrity when sipped and exposed to hot liquids, such as coffee, tea or soup.

Access holes are known to be provided in pasta products, such as in U.S. Pat. No. 2,950,978 of Milani but the purpose is to access the boiling water to the interior products, such as ravioli cheese, to permit its boiling, not to make it more absorbent. U.S. Pat. No. 6,203,830 of Cademartiri discloses producing filed pasta to be conventionally cooked. Additionally U.S. Pat. No. 4,721,622 of Kingman discloses a snack product including a filling enclosed in a bread-like casing, with a plurality of vapor escape holes used for ultimately heating the product.

Another filled snack product is the peanut butter and jelly sandwich formed with bread, of the SMUCKERSO company, wherein the outer edges thereof are sealed by crimping, as disclosed in U.S. Pat. No. 6,004,596. However, the outer shell is bread-like and soft, not crispy enough to withstand exposure to hot liquids such as coffee, tea or soup, for any substantial period of time, such as eight to ten seconds.

Moreover, traditional doughnuts, such as those of DUNKIN DONUTS® maintain their shape only momentarily, as the dipped portion dissolves quickly in hot liquids, and the only remaining portion with any structural integrity is the portion of the donut not dipped into the hot liquid.

Other related patents include U.S. Pat. No. 5,968,570 of Paulucci for a folded pastry product which maintains its structural integrity after being microwaved, such as microwavable LEAN POCKETS® pastry products filled with meat or egg products. U.S. Pat. No. 6,399,128 of Ballesteros describes filling a bagel or other bakery product by withdrawing some of the original interior dough and filling the inside of the bagel with a filling. U.S. Pat. No. 3,666,485 of Nelson discloses making a filled food product, but which is filled with a hydrophobic product such as cream, cheese, jellies or other oily products. A cream-filled product is also disclosed in U.S. Pat. No. 6,231,899 of Rosso. A filled shell product which is filled with hydrophobic food products, such as jelly, cheese or ice cream, is also disclosed in U.S. Pat. No. 4,808,422 of Ward.

Filled cookies are disclosed in U.S. Pat. No. 4,948,602 of Boehm, wherein both hydrophobic products such as chocolate cream and water based fillers, such as marshmallows, are inserted in the cookie. However, the sugar-based marshmallow is not palatably consistent with coffee, tea or soup.

Cracker based crusts filled with hydrophobic products such as cheese, jelly, peanut butter, cream filling or meat and fish based fillings are disclosed in U.S. Pat. No. 5,000,968 of Szwerc.

Breadsticks are known such as described in U.S. Pat. No. 5,260,075 of Haegens and Design Pat. Des 266,030 of Madonia. Corn based crusts are disclosed in U.S. Pat. No. 5,554,405 of Fazzolare. Fluid-filled pastries filled with milk or fruit juice are disclosed in U.S. Pat. No. 4,209,536 of Dogliotti.

Confectionery candy products with crunchy confectionery non-breaded outer shells are known, with soft liquid interior fillings, but these products tend to be hydrophobic, and do not expand or turn to a soft absorbent filling when contacted by hot liquids, since they are meant to be eaten at ambient air room temperature without being submerged in hot liquids.

Therefore there is a need for a structurally integral, manually holdable foodstuff snack which has a crispy outer shell and a liquid absorbent, hydrophilic interior filling.

### OBJECTS OF THE INVENTION

It is therefore an object of the present invention to provide an edible manually holdable food product with a hydrophilic liquid absorbent filling insert.

### SUMMARY OF THE INVENTION

The present invention includes breadsticks and breakfast sticks, each including a crispy, crunchy hard outer shell having an absorbent component therein, to permit the consumer to be able to dip the stick into fluids, such as soup, tea, milk, etc, with the outer shell maintaining its structural integrity while the inner component absorbs the liquid throughout. This enables a person to have the advantage of having a liquid saturated component within a structurally sound crispy and/or crunchy outer shell with limited liquid absorption properties, to facilitate manual holding of the stick until consumed.

### BREADSTICK EMBODIMENT

In a first breadstick embodiment, the breadstick includes a hard crusty shell with absorbent bread in the middle.

This typical breadstick is formed by first making the crispy outer shell by mixing approximately two cups of corn meal with one half cup of white flour, one quarter teaspoon salt, one half teaspoon garlic powder or other seasonings with one half cup, plus two tablespoons, of water.

The mixed ingredients are mixed together, forming a semi-dry dough. This dough is rolled out onto a baking sheet, punched with absorbing holes to provide access to the interior of the rolled breadstick. The dough is cut into sections, and absorbent material, such as dehydrated bread, is inserted onto the dough and the filled dough is rolled into a substantially cylindrical product. The product is baked at 375 degrees Fahrenheit for approximately twelve to sixteen minutes.

The resultant product is an outer crispy shell filed with an absorbent interior filling. The outer shell remains crispy and substantially non-absorbent in hot liquids, such as soup or coffee, and the inner filling absorbs the hot fluid therefrom introduced into the punched access holes.

As a result, a person working in the field, such as a bricklayer, landscaper or construction worker, can insert the breadstick into the hot liquid and hold it tangibly, unlike traditional bread, which will tend to lose its stability and melt within the hot liquid, rendering it difficult to be held in the hand of the worker.

Preservation of the product for a long shelf life can be accomplished by the packaging and by use of artificial or non-artificial preservatives.

For a breakfast stick, the same shell can be produced, but the interior is filed with a sweeter absorbent product.

The breadstick is dipped into soup (or other liquid food) for a substantial interval of time, such as eight to ten seconds. The soft absorbent center absorbs the hot soup or other hot liquid, and when bitten into, the outside shell remains crunchy, while releasing absorbed liquid from the center through the access holes provided in the outer crust.

The crispy-crunchy outer shell has several small random openings throughout the up-side section, allowing for the absorption of the liquid. The openings can be of different shapes and sizes, i.e. stars, circles, etc. Additionally, the top and/or bottom of the outer shell may be open, permitting fluid flow therethrough.

The outer shell will have different flavors such as: sesame seed, poppy seed, onion, garlic, and/or a combination of flavors.

Combined with the absorbent center, the hard outer shell can be folded over center in various ways, such as: wrapped, twisted, braided, etc.

The breadstick may be consumed alone or dipped into soup or other such liquid form.

### BREAKFAST STICK EMBODIMENT

The crunchy outer shell can be sugar-coated or frosted, or the batter of the outer shell may include different sugary flavors, such as: cinnamon, honey, vanilla, etc.

The absorbent center may also include various flavors and/or fillings, such as: fruit filling or flavoring, jelly filling, nutty flavoring, etc., as long as they are hydrophilic and water or other liquid absorbent.

Combined with the absorbent center, the outer shell may be folded in various ways, such as being wrapped, twisted, braided, or adhered with a sugar glaze.

In an alternate embodiment, the soft absorbent center material can be dehydrated or crispy, when baked, deep fried or cooked with hot oil during baking, with a hard crusty shell, before being eaten by contact with the liquid.

Furthermore, the absorbent center can be inserted into the already baked crusty shell, which can be optionally sealed at one or both ends after insertion of the absorbent center. The shell can also have optional outer side holes or can be optionally open at one or both ends, permitting fluid flow therethrough.

The absorbent center can be soft or dehydrated and crisp, as long as it is hydrophilic and has an absorbent nature. If dehydrated, the absorbent materials may be temporarily held together by honey, flavor paste, etc.

An alternate embodiment is for a discrete crusty egg-white frosting type confectionery shell, instead of bread, for the outside. This has the same absorbent inner components as before.

This is a distinct shell, as opposed to just a thin egg coating on challah bread (to form a crust).

### DESCRIPTION OF THE DRAWINGS

The present invention can best be understood in connection with the accompanying drawings. It is noted that the invention is not limited to the precise embodiments shown in drawings, in which:

FIG. 1 is perspective view of a hole-making roller contacting a sheet of outer unbaked shell dough of a filled breadstick.

FIG. 2 is a side elevational view of the filling of each filled breadstick.

FIG. 3 is an end view showing the folding of the outer unbaked shell dough of a filled breadstick over the inner contents of each filled breadstick.

FIG. 4 is a perspective view of the breadstick as assembled in FIG. 3 in a baked condition.

FIG. 5 is a perspective view showing the dipping immersion of a baked or fried filled breadstick into a liquid such as a heated liquid, such as soup, coffee or tea, or a cold liquid, such as milk.

FIG. 6 is a perspective view showing the withdrawal of a liquid saturated baked filled breadstick into a liquid, showing the saturated portion thereof.

FIG. 7 is a legend showing alternative typical moist and dry fillings forming the filled breadstick.

FIG. 8 is a perspective view showing a breadstick shell filled with a monoblock of absorbent bread type material;

FIG. 8A is a side elevation view of the monoblock of absorbent bread type material as in FIG. 8;

FIG. 9 is a detail view of a dehydrated fill material to be inserted in the breadstick of the present invention;

FIG. 10 is a close-up perspective view of an embodiment for breadsticks filled with dry breakfast cereal; such as corn flakes, crisped rice and fruit flavored looped cereals;

FIG. 11 is a side view of a cylindrical breadstick open at each end, showing a pair of crimped ends;

FIG. 12 is a perspective view of an embodiment for a breadstick with no exterior holes other than at least one end hole;

FIG. 13 is a perspective view of an embodiment formed like a sandwich of respective upper and lower flattened layers, having an insert of absorbent material, wherein the absorbent material is bonded by a coating or slurry to the inner sides of the respective upper and lower flattened layers;

FIG. 13A is a cross sectional view of the embodiment as in FIG. 13;

FIG. 14 is a perspective view of an embodiment for a breadstick product in the shape of a hot dog roll having a crevice for insertion of an absorbent insert therein; and,

FIG. 14A is a perspective view of an embodiment for a breadstick in the shape of a New England-type hot dog roll having a crevice for insertion of an absorbent insert therein.

### DETAILED DESCRIPTION OF THE DRAWINGS

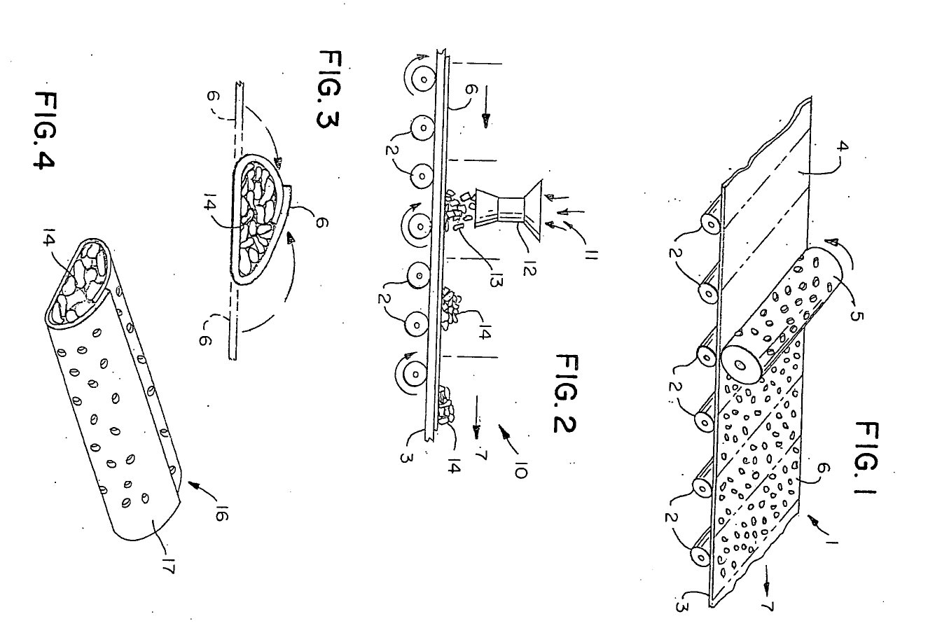

This invention is well described by FIGS. 1 through 14A illustrating a breadstick product with a crunchy or crusty outer shell resistant to liquid absorption which is filled with a variety of absorbent (hydrophilic) food products. The intent is to dip (or “dunk”) the breadstick product prior to eating into a hot or cold liquid such as coffee, tea, soup or milk as appropriate to the filling.

FIGS. 1 through 4 illustrate steps in the production of breadstick 16 shown in FIG. 4 with crunchy, hard, perforated outer shell 17 and absorbent food filling 14; breadstick 16 is the first embodiment of this invention.

FIG. 1 shows an early step with shell dough 4 being perforated by roller 5 as conveyor belt 3 moves in direction 7 as urged by rollers 2.

FIG. 2 shows a later step along conveyor belt 3 wherein perforated dough strips 6 pass under hopper 12 which deposits filler food items 13 into measured piles 14. Filler items are replenished 11 into hopper 12 at its top opening.

In FIG. 3, unbaked dough strip 6 is folded over prior to baking into hard shell 17 depicted in FIG. 4.

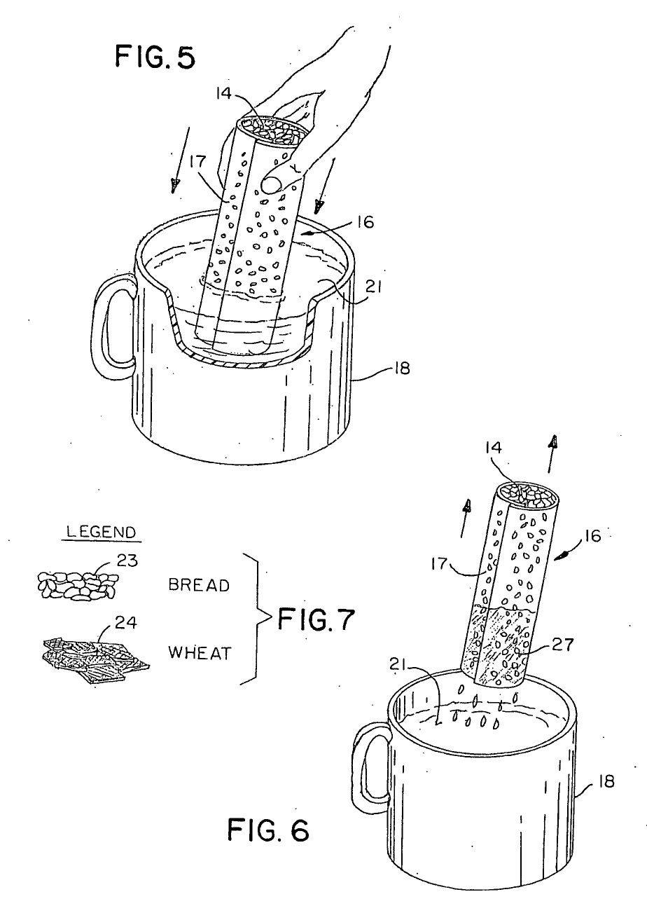

FIG. 5 shows breadstick 16 being dunked into liquid 21 (coffee, tea, soup, milk, etc.) in cup 18.

Upon being withdrawn from cup 18 (as in FIG. 6), lower portion 27 which had been previously dunked, now contains filling 14 which is saturated with liquid 21. In FIG. 4, outer shell 17 has an oval crossection. In FIG. 5, outer shell 17 is shown being cylindrical with a circular crossection. Other geometric shapes may be used. However, breadstick 16 maintains its structural integrity to permit movement, intact, to the person's mouth.

FIG. 7 is a detail showing two possible varieties of filling 14 such as bread crumbs 23 or wheat cereal pieces 24.

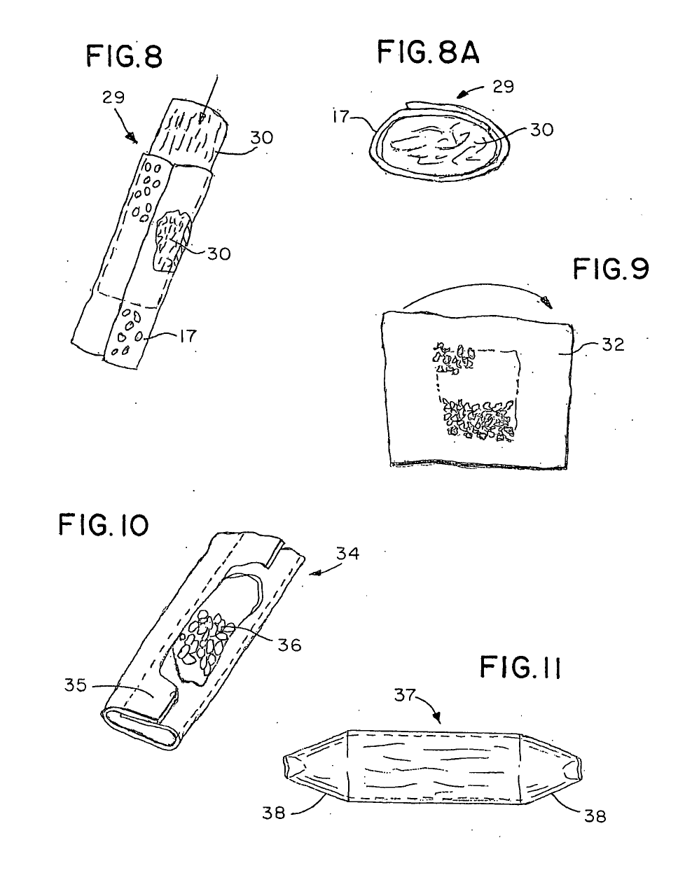

The second embodiment shown in FIGS. 8 and 8A, shows breadstick 29 with the same outer shell 17 but now filled with a solid monoblock 30 of absorbent food such as bread of any flavor.

FIG. 9 shows alternate dehydrated powder or granular food fill material which can include jelly, jam, peanut butter, or grated cheese. Normally these ingredients are hydrophobic, but their dehydrated versions are highly hydrophilic. If not sufficiently absorbent, the ingredients can be coated or encapsulated with absorbent material.

FIG. 10 shows breadstick 34, a third embodiment, with sweet hard shell 35 filled with crisped rice or fruit flavored loop type cereal pieces 36. FIG. 10 shows shell 35 being a folded, partially flattened cover. This configuration can be used with any of the embodiments herein.

FIG. 11 shows a fourth embodiment of this invention in the form of breadstick 37 with tapered crimped ends 38 to help hold the ingredients in place.

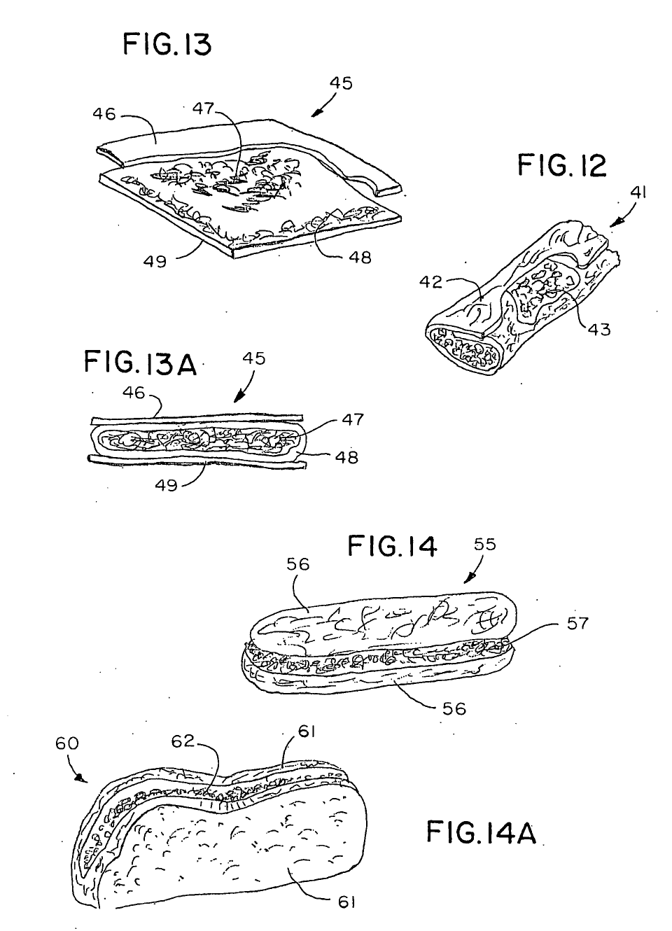

FIG. 12, a fifth embodiment, shows breadstick 41 with unperforated shell 42 with corn flakes 43 as the filling. Other fillings can be used as well. One end or both ends can be open.

FIG. 13, a sixth embodiment, shows a “breadstick” of this invention transformed into a square sandwich 45 with hard outer shells, 46 on top and 49 on the bottom. Filling 47 can be powdered food material such as described in FIG. 9. It is held in place and bonded to the inner surfaces of shells 46 and 49 by a compatible slurry 48. This would either be neutral in taste or slightly salty with a cheese filling. It would be neutral or slightly sweet to be compatible with sweet fillings. This slurry must be permeable to liquid, but not as absorbent as the filling itself.

FIG. 13A is a crossectional side view of FIG. 13.

FIG. 14 shows a seventh embodiment of this invention in a novelty shape 55 to simulate a filled hot dog bun 56 with absorbent filling 57.

An eighth embodiment 60 is shown in FIG. 14A. Technically similar to FIG. 14 in terms of shell 61 and filling 62, its shape is that of a folded New England-type hot dog roll. A variation of this shape using a thinner crunchy shell would simulate a taco. The latter could be filled with a bean flavored absorbent filling containing dehydrated beans.

In additional embodiments, the absorbent filing may be comprised of potatoes in a cooked, mashed, parboiled or dehydrated form; vegetables that are cooled, mashed, parboiled or dehydrated, such as root vegetables for example carrots and/or stalk vegetables for example celery or broccoli; foods combined with starch flours; tofu; pastas, bulgar, rice, mushrooms, grains, dried fruits, and combinations thereof. The above potential filings may be used in a cooked form, such as boiled potatoes and then frozen or refrigerated, or may be used in a dehydrated form for longer storage and easier transport of the food product. The fillings, above, may be steam cooked, boiled to an “al dente” level, i.e. slightly undercooked, or baked, depending on the vegetable, to ensure that the filling is not saturated with water before it is added to the breadstick or breakfast stick shell.

Minor amounts of other ingredients may be added to any of the foregoing embodiments to enhance flavor and taste.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. A breadstick product comprising:
a hard crusty shell of edible material having punched access holes; and
said shell filled with an interior filling of edible hydrophilic material.

2. The breadstick product of claim 1 in which the edible filling material is dehydrated.

3. The breadstick product of claim 2 in which the dehydrated filling material is bread.

4. The breadstick product of claim 2 in which the dehydrated filling material is selected from the group consisting of jelly, jam, peanut butter, and cheese.

5. The breadstick product of claim 1 in which the hydrophilic material is selected from the group consisting of corn flakes, crisped rice, rice, bulgar, grains, dried fruits, potatoes, vegetables, tofu, mushrooms, fruit flavored looped cereals, starch based foods and combinations thereof.

6. A method of making a breadstick product comprising the steps of:
mixing corn meal, white flower, salt, garlic powder and other seasonings with water to form a semi-dried dough;
rolling out the dough onto a baking sheet;
punching the dough on the baking sheet with access holes;
covering the dough on the baking sheet with a hydrophilic edible food;
shaping the filled dough into a shaped product in which there is an outer shell of the dough with an interior filled with said hydrophilic edible food; and
baking said shaped product forming a breadstick product having an outer crispy shell filled with a hydrophilic filling capable of retaining its shape while being dunked repeatedly into a liquid food product.

7. The method of claim 6 in which the hydrophilic edible food is dehydrated.

8. The method of claim 7 in which the dehydrated food is a bread.

9. The method of claim 6 in which the hydrophilic edible food is selected from the group consisting of dehydrated jelly, jam, peanut butter and cheese.

10. The method of claim 6 in which the hydrophilic edible food is selected from the group consisting of corn flakes, crisped rice, fruit flavored looped cereals, rice, dried fruits, bulgar, grains, potatoes, vegetables, tofu, mushrooms, starch based foods and combinations thereof.

11. The method of claim 6 in which the shaped product is a cylinder with ends left open.

12. The method of claim 6 in which the shaped product is a cylinder with ends left partially open.

13. The method of claim 6 in which the shaped product is a folded shell with said hydrophilic edible food sandwiched between sides of said shell.

14. The method of claim 6 in which said shaped product is in the shape of an oval in crossection.

15. The method of claim 6 in which said shaped product has tapered ends.

16. The method of claim 6 in which said shaped product has side holes.

17. The method of claim 6 in which said shaped product is in the shape of a square sandwich.

18. The method of claim 6 in which said shaped product is hot dog roll shaped.

19. The method of claim 6 in which said shaped product is folded.

20. The method of claim 6 in which the ratio of corn meal to white flour is about two cups of the corn meal to each one half cup of the white flour.

21. The method of claim 6 in which the dough on the baking sheet is cut into sections before adding the hydrophilic material so that a plurality of breadstick products are prepared at the same time.
